(19) United States
(12) Patent Application Publication
(10) Pub. No.: US 2022/0375371 A1
(43) Pub. Date: Nov. 24, 2022

(54) AUTOMATIC FLAG DISLPAYER

(71) Applicants: Courtney McCutchen, Hudson, WI (US); Alex Webb, Hudson, WI (US)

(72) Inventors: Courtney McCutchen, Hudson, WI (US); Alex Webb, Hudson, WI (US)

(21) Appl. No.: 17/324,658

(22) Filed: May 19, 2021

(51) Int. Cl. G09F 17/00

(52) U.S. Cl. CPC G09F 17/00; G09F 2017/0025; G09F 2017/0066

(57) ABSTRACT

The automatic flag displayer is a weather-proof device that can be mounted and used to display a flag during appropriate times, without needing someone to manually fetch the flag and roll or unroll it. Instead, the automatic flag displayer comes with a remote control with buttons to control the necessary actions of opening or closing the rubber-sealed shutter doors where the flag is stored when not flown, lowering or raising the flag, and rolling or unrolling the flag. When the rubber-sealed shutter doors open, the flag hinge and the associated flag hinged arm can be manipulated by said remote to angle the flag out of the box. The combination of the hinge and the hinged arm provide structural support to the flag and secure it against strong winds or other hazardous weather conditions.

### BACKGROUND

A flag is a piece of fabric (most often rectangular or quadrilateral) with a distinctive design and colors. It is used as a symbol, a signaling device, or for decoration. National flags are patriotic symbols with widely varied interpretations that often include strong military associations because of their original and ongoing use for that purpose. Flags are also used in messaging, advertising, or for decorative purposes. There have been no products available as original equipment or as an aftermarket to address this problem.

Hoisting the flag is the act of raising the flag on the flagpole. Raising or lowering flags, especially national flags, usually involves ceremonies and certain sets of rules, depending on the country, and usually involve the performance of a national anthem. Some rules of flag etiquette also apply to the lowering of the flag, and when the flag should be flown. For example, on special days, the flag may be flown at half-staff. On Memorial Day it is flown at half-staff until noon and then raised. There have been no products available as original equipment or as an aftermarket to address this problem either.

There exists a need for an automatic flag displayer that is not being met by any known or disclosed device or system of present.

### SUMMARY OF THE INVENTION

The automatic flag displayer is a weather-proof device that can be mounted and used to display a flag during appropriate times, without needing someone to manually fetch the flag and roll or unroll it. Instead, the automatic flag displayer comes with a remote control with buttons to control the necessary actions of opening or closing the rubber-sealed shutter doors where the flag is stored when not flown, lowering or raising the flag, and rolling or unrolling the flag. When the rubber-sealed shutter doors open, the flag hinge and the associated flag hinged arm can be manipulated by said remote to angle the flag out of the box. The combination of the hinge and the hinged arm provide structural support to the flag and secure it against strong winds or other hazardous weather conditions.

A flag display system disclosed includes a flag display device having a flag mast, a swivel pivot attached to an end of the flag mast, a swinging arm attached to a portion of the flag mast distal from the pivot end and a rotating portion of the flag mast. The disclosure also includes a housing for the flag display device, the housing comprising at least one hinged door configured to swing open and allow a flag attached to the rotating portion of the flag mast to drop from the housing based on the swivel pivot

### BRIEF DESCRIPTION OF THE DRAWINGS

FIG. 1 is a view of the automatic flag displayer when the flag is put away and the shutters are closed in accordance with an embodiment of the present disclosure.

FIG. 2 is a view of the automatic flag displayer when the flag is out and the shutters are open, but the flag is rolled up in accordance with an embodiment of the present disclosure.

FIG. 3 is a view of the automatic flag displayer when the flag is out and unrolled for display with the shutters open in accordance with an embodiment of the present disclosure.

FIG. 4 is a view of the automatic flag displayer for a rolling storage operation in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term [term] is used to refer to [describe, rest of sentence]. The term [term] refers to [describe, rest of sentence].

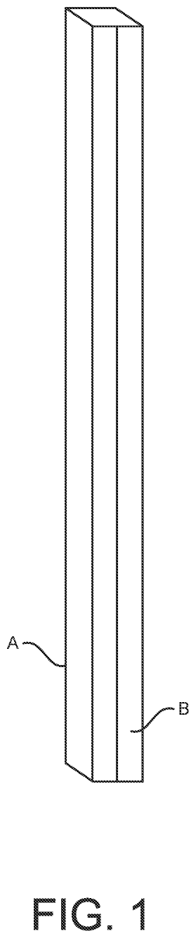

FIG. 1 is a view of the automatic flag displayer when the flag is put away and the shutters are closed in accordance with an embodiment of the present disclosure. Shown is the weather-proof mount box A, with rubber sealed shutter doors B.

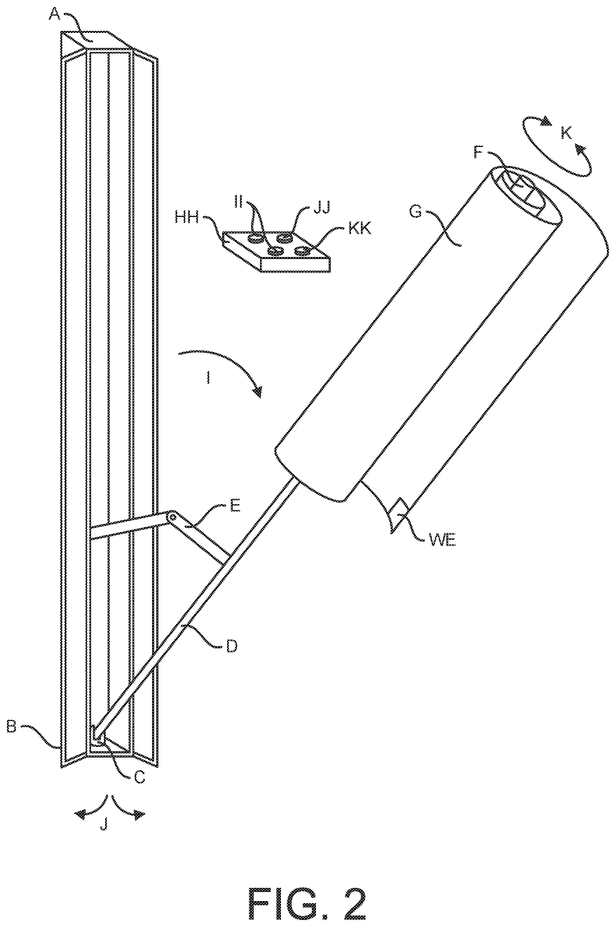

FIG. 2 is a view of the automatic flag displayer when the flag is out and the shutters are open, but the flag is rolled up in accordance with an embodiment of the present disclosure. Shown is the weather-proof mount box A, with rubber sealed shutter doors B. When the doors open, the flag G may be lowered out of the box on a hinge C. Additionally, a hinged arm E holds the flag and its flag pole D in place. The automatic flag displayer is controlled by a remote control H with four buttons: two buttons II to raise or to lower the flag, a button JJ to open or close the doors, and a button KK to roll out or roll up the flag. Degrees of motion are indicated in the present view including the furl and unfurl first degree of motion K, the flag raise and lower second degree of motion I and the flag mast swivel third degree of motion J as indicated by arrows. The weighted end WE helps the flag to unfurl and furl properly against a force of gravity on the weighted end WE.

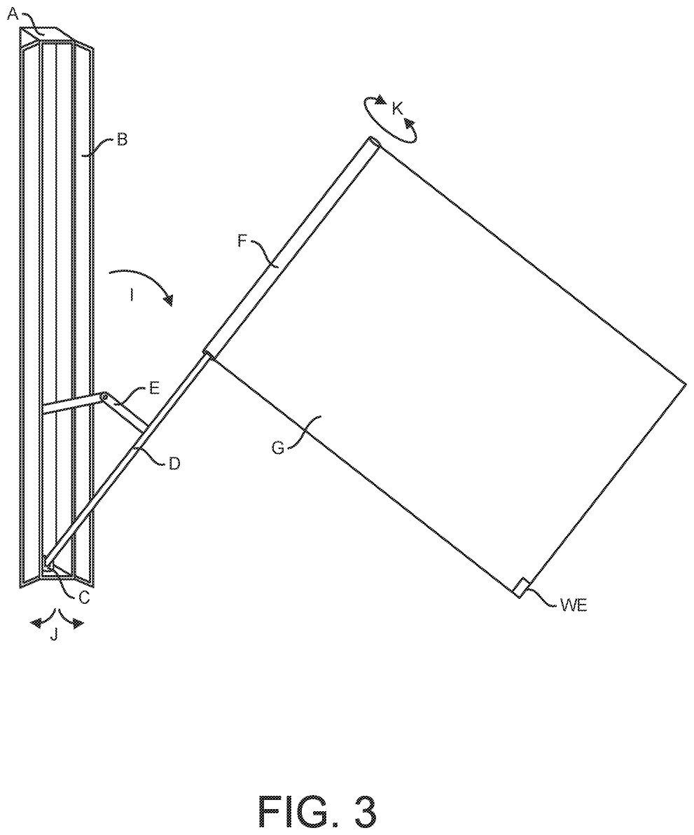

FIG. 3 is a view of the automatic flag displayer when the flag is out and unrolled for display with the shutters open in accordance with an embodiment of the present disclosure. Shown is the weather-proof mount box A, with rubber sealed shutter doors B. When the doors open, the flag G may be lowered out of the box on a hinge C. Additionally, a hinged arm E holds the flag and its flag pole D in place. The automatic flag displayer is controlled by a remote control H with four buttons: two buttons I to raise or to lower the flag, a button J to open or close the doors, and a button K to roll out or roll up the flag.

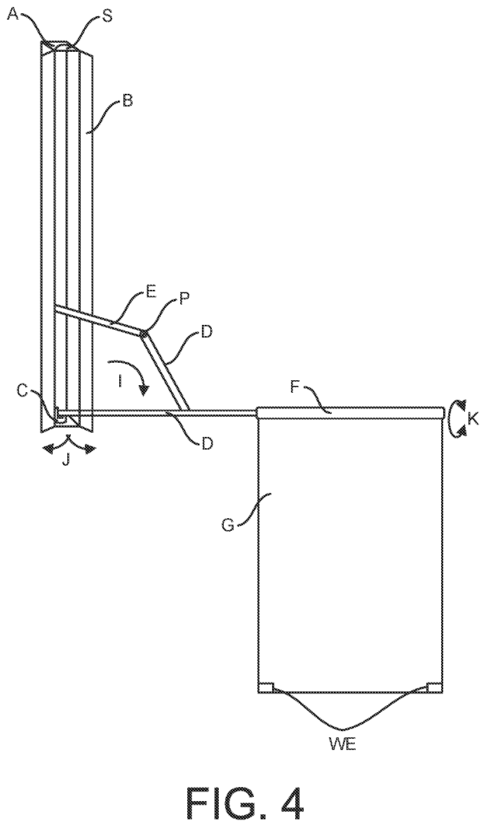

FIG. 4 is a view of the automatic flag displayer for a rolling storage operation in accordance with an embodiment of the present disclosure. The view includes the limitations of the foregoing views and same or similar reference characters. The view also includes two weighted ends WE for superior automatic rolling of the fully extended ninety degree angle between the flag and the storage box. The pin P acts as a pivot hinge to the operation. Other embodied methods to open and close the disclosure are triggered by a day/night photosensor S. The photosensor S is a primary means to display the autoflag offering a “touchless” and automated experience. Alternating current (AC) and direct current (DC) power sources are included in the box A.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A flag display system comprising:
a flag display device comprising a flag mast, a swivel pivot attached to an end of the flag mast, a swinging arm attached to a portion of the flag mast distal from the pivot end and a rotating portion of the flag mast; and
a housing for the flag display device, the housing comprising at least one hinged door configured to swing open and allow a flag attached to the rotating portion of the flag mast to drop from the housing based on the swivel pivot.

2. The system of claim 1, further comprising the flag having a weighted end to enable the flag to unfurl via a force of gravity on the weighted ends.

3. The system of claim 1, further comprising a spring internal to the flag mast and configured to windup on a furling of the flag and to unwind on an unfurling of the flag, a spring force of the spring greater than a weight force of the flag.

4. The system of claim 3, wherein a spring force of the spring is greater than a weight force of the flag but less than the weight force of the flag plus a weight force of a weighted end on the flag.

5. The system of claim 3, wherein an end of the spring internal to the flag mast distal the pivot end is attached thereat and an end of the spring proximal to the swivel pivot end is attached to a twisting mechanism.

6. The system of claim 1, further comprising a twisting motor adjacent the swivel pivot and attached to an end of an internal spring configured to wind and furl the flag and unwind and unfurl the flag.

7. The system of claim 1, wherein the at least one hinged door comprises a weatherproof seal with the housing.

8. The system of claim 1, wherein the swivel pivot is configured to swivel from a vertical position parallel with the housing to within a ninety degree position from the housing based on a ratchet on the swivel pivot to the housing.

9. The system of claim 1, wherein the swinging arm is configured to swing from a vertical position parallel with the housing to within a ninety degree position from the housing based on an elbow hinge between two portions of the swinging arm.

10. The system of claim 1, wherein the flag mast has a stationary portion proximal the swivel pivot and a rotating portion distal the swivel pivot.

11. The system of claim 1, wherein the housing is adapted to mount the swivel pivot and the swinging arm within and enclose a flag attached to the flag mast.

12. The system of claim 1, wherein the flag unfurls in a first degree of motion via the flag mast and moves on the swivel pivot via the flag mast in a second degree of motion and extends from the housing via the swinging arm on the flag mast in a third degree of motion.

13. The system of claim 1, further comprising a remote control for controlling the system via an electronics circuit and a servomechanism.

14. The system of claim 1, further comprising an electronic circuit and a servomechanism configured to unfurl and to furl the flag on the mast in a first degree of motion.

15. The system of claim 14, further comprising an electronic circuit and a servomechanism configured to move the flag mast on the swivel pivot in a second degree of motion.

16. The system of claim 14, further comprising an electronic circuit and a servomechanism configured to extend the flag mast from the housing via the swinging arm in a third degree of motion.

17. The system of claim 1, further comprising an electronic circuit and a servomechanism configured to rotate the flag mast in a furling and in an unfurling first degree of motion.

18. The system of claim 1, further comprising an electronic circuit and a servomechanism configured to open the at least one hinged door on the housing.

19. The system of claim 12, further comprising a remote control configured to control the three degrees of motion via an electronics circuit and a servomechanism.

20. The system of claim 1, further comprising a remote control configured to control a raising and a lowering of the flag, an opening and a closing of the at least one hinged door and a furling and an unfurling of the flag.
